(19) United States
(12) Patent Application Publication
(10) Pub. No.: US 2008/0118694 A1
(43) Pub. Date: May 22, 2008

(54) Prime pressure sensitive label assembly having lenticular properties displaying multiple imaged patterns

(75) Inventor: Jesse D. Crum, Fort Scott, KS (US)

Correspondence Address: Attn: Stephanie Hay;Ward/Kraft, Inc., 2401 Cooper St., Fort Scott, KS, 66701, US

(73) Assignee: Ward/Kraft, Inc.

(21) Appl. No.: 12/001,020

(22) Filed: Dec. 7, 2007

Related U.S. Application Data
(63) Continuation-in-part of application No. 11/178,678, filed on Jul. 11, 2005.

(51) Int. Cl. B32B 33/00; B41M 5/00

(52) U.S. Cl. 428/41.8; 428/195.1

(57) ABSTRACT

The present invention is directed to a prime label assembly in which a printed image is applied to a first face and the image is substantially covered with a curable varnish. A plurality of distinct patterns can be created in the varnish layer, with each of the patterns occurring in areas separate from one another and with each pattern creating a distinct visually discernable image.

### CROSS-REFERENCES TO RELATED APPLICATIONS

This case is a continuation-in-part of Ser. No. 11/178,678.

### FIELD OF THE INVENTION

The present invention is directed to the field of preparation of pressure sensitive, magnetic or wide-web materials for use in the creation of unique business communication assemblies, namely prime pressure sensitive labels, magnetic layer backed or wide-web products that have transitional imaging properties imparted to the substrate. More particularly, the instant application relates to the manufacture of coated substrates that can be produced in an economical and efficient fashion to render enhanced surface characteristics to the information handling document, in order to create dimensionally distinct surface viewing areas. Practice of the present invention can be performed in a continuous fashion, such as in a web format, or alternatively, the business communication documents can be prepared in a sheet wise configuration.

### BACKGROUND OF THE INVENTION

The preparation of products, novelties and printed materials having three dimensional appearances is generally well known and may be described as using lenses that have a series of lenticules that create a perception of a different image when an image is viewed through the lenticules at differing angles. That is, when the substrate on which the lens has been placed is shifted in one's line of sight, the image appears to change due to the angle at which the image is viewed and the distortion caused by the individual lenticules.

Normally, such three dimensional items are produced in relatively limited quantities due to the cost associated with manufacturing the item. For example, distributing products that have various lenticular properties may be limited to certain target markets based on previously determined demographics for it is anticipated that the small, but focused approach will yield a higher return on the investment when compared with blanket mailings.

Historically, products having lenticular properties have been prepared by applying a plastic lens over a printed item, with the lens having preformed lenticules provided therein. The lenticules may be crated through any number of known methods such as by etching, abrading, grinding, etc. The lens is then laminated to a previously prepared image directly, which may have been reverse printed, so that the image is visible through the lens. Shifting of the piece to change the angle or view of the piece then causes the image to appear to change due to the different angles through which the image is viewed.

As might be expected, the cost of preparing a plastic or other resinous material incrementally increases the expense of manufacturing such products due to the mechanical abrading or embossing processes as well as the need to procure plastic sheeting. Therefore, typically, multiple dimensional products have been limited to more high value items such as security products, trading or novelty cards, greeting cards, high end promotional activity and the like.

U.S. Pat. Nos. 5,285,238 and 5,457,515 each describe a continuous process in which a curable resinous material is applied to a transparent web, lenticules are created in the material and the material is then cured to fix the lenticules in the web. The web is then affixed to a second web carrying an image so that the image is visible through the lenticular lens that has been created substantially in-situ.

In an alternate embodiment disclosed in U.S. Pat. No. 5,285,238, the resinous coating is applied directly to one side of a single web to create the lenticules and an image applied to a “flat side” opposite the side of the coating without the necessity of laminating the lenticular web to the image web, see abstract. However, the system described still is relatively complex in its application as the imaging must occur at a pre-determined angle to that of the direction of the travel of the web so that the hoped for lenticular affect is obtained.

One of the potential drawbacks of using a curable resin, such as a plastic resin is that the resin may make the underlying image appear cloudy or foggy when viewed at various angles when shifting the image in one's line of sight. This potentially can detract from the overall presentation of the product.

What is needed therefore is an economical and simple to use system in which a coating can be applied in a fashion, ranging from continuous to selective, without the aforementioned drawbacks associated with the prior art systems.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly it has been found that a relatively inexpensive overprint, curable varnish material can be used to create interesting visual effects, when the coating is applied in a suitable thickness. The varnish can be used to create a surface similar to lenticular lenses that have been used in the past. It has been discovered that a cost effective and simple solution can be used to create printed or imaged business communication substrates, namely prime pressure sensitive labels, magnetic backed or wide-web products that possess lenticular properties without the need to laminate expensive webs or lenses to the printed web. More importantly, the UV curable overprint varnish coating creates a glossy appearance that mimics more expensive plastic or resinous materials creating an economical alternative to thereby expand the use of the lenticular effect to other areas where it may have been previously unavailable.

In one exemplary embodiment that may be practiced in accordance with the present invention, a pressure sensitive prime label assembly, is described and includes a release liner that has first and second faces, with the first face having a coating of release material applied substantially over the first face. A pressure sensitive adhesive layer is applied over the first face of the release liner. In the case of a magnetic layer backed product, a magnetized layer is used in place of the release liner, while ia wide-web product such as a poster, the adhesive and release liner are omitted.

Continuing with a discussion of the presently described embodiment a printable layer is applied over the adhesive layer, with the printable layer having first and second faces with at least the first face having an image produced thereon.

A curable coating material is applied over at least the first face and at least first and second patterns are created in the curable coating material over the first face, with the first pattern being distinct from the second pattern and each of the first and second patterns creating distinct dimensional images.

In a further exemplary embodiment that may be practiced in accordance with the present invention, a permanent pressure sensitive prime label is described and includes a first layer that has first and second faces with at least one of the faces having an image applied thereto. A curable varnish is applied over the image so as to at least substantially cover the image.

Continuing with a description of the presently described embodiment, a permanent pressure sensitive layer is applied to the second face of the first layer. The permanent pressure sensitive layer is covered by a release liner.

A first pattern is created in a first area of the curable varnish and a second pattern distinct from the first pattern is created in a second area of the curable varnish.

In a yet still further exemplary embodiment that may be practiced in accordance with the present invention, a prime label assembly is described and includes a first layer that has an image that is deposited on a first face. The image has a resolution of greater than about 150 lines per inch. A layer of adhesive is applied to the first layer on a second face opposite the first face. The layer of adhesive is covered by a release liner.

A UV curable coating is applied over the image and at least first and second patterns are created in the UV curable coating. The first and second patterns are created in first and second areas that are distinct from one another.

In one or more of the previously described embodiments, a high quality image, such as one having a resolution of greater than 150 lines per inch, and preferably greater than about 250 lines per inch is applied to at least the first face of the substrate or layer. The image is applied between the first and second transversely extending edges and first and second longitudinally extending sides.

In one or more of the previously described embodiments, a curable overprint varnish that has a thickness ranging from about 0.0002″ to about 0.005″ is applied to the first face of the substrate or layer and directly over the image. The varnish includes a first component that ranges from 0.01% by weight to 99.99% by weight and a second component that ranges from 0.01% by weight to about 99.99% by weight. The patterns are preferably created in the coating while the coating is still in a fluid state to create dimensionally distinct, visually perceptible patterns on the substrate or layer, and over the image when the substrate is viewed at different angles. The coating is hardened to fix the pattern by curing.

In the foregoing embodiments, any of the patterns that are imparted to the coating create a series of regularly occurring peaks and valleys in the coating such that the pattern provides a transitional image when the image is viewed at different angles. After the coating is cured a prime label having a multiple dimensional view is created.

In each or any of the foregoing embodiments, a third pattern may be provided in the coating, with the third pattern being provided in a third area distinct from the first and second areas and the third pattern being visually, perceptibly distinct from each of the first two patterns.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross-sectional view of a prime label assembly that may be produced in accordance with one or more embodiments of the presently described invention;

FIG. 2 shows a front view of an assembly that may be produced in accordance with one or more embodiments of the presently described invention and showing a plurality of patterns;

FIG. 3 depicts a cross sectional view of the patterned area of the curable coating showing the regularly occurring peaks and valleys;

FIG. 4 illustrates a side elevation view of an assembly that may be produced in accordance with one or more embodiments of the presently described invention in a continuous roll configuration; and

FIG. 5 provides a cross-sectional view of an assembly that may be produced in accordance with one or more embodiments of the presently described invention in an alternate configuration.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Unexpectedly, it has been discovered that patterns can be produced that resemble and function as traditionally produced lenticular assemblies without the need to create expensive overlays, or laminated constructions as heretofore has been previously known. In addition, through the use of the present embodiments it has been discovered that a significantly higher degree of variability can be provided to the end user when preparing intermediates in accordance with the present invention.

Overprint varnishes have historically been used by the printing industry and are usually applied to the surfaces of printed substrates to provide a glossy coating. The coatings are normally applied to create a relatively thin layer so as to not obscure or cloud features of the printing beneath the coating. However, to date, the inventors of the instant application are unaware of the use of such coatings in a relatively thick overcoat to create a substrate having multidimensional properties.

A number of terms are used in connection with describing the present invention and the following descriptions are used to illustrate but not unnecessarily limit the possible meaning of such terms.

The term “patterns” as used herein refers to continuous strips, lines, shapes, spots, dots, elements, and discontinuous segments as well as regular and irregular placement of such items. Patterns may also refer to combinations of the above mentioned items such that one pattern may be a continuous strip; another segmented elements and yet still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters and the like. For example, one may wish to include a name of a company in connection with a particular theme or season.

Preferably in connection with the present invention, the patterns used to form the lenticular effect, that is the patterns formed in the overprint varnish, will be provided in a regularly occurring arrangement of relatively parallel striations that will be substantially adjacent one another. The striations may occur in the “X” or “Y” axis, may run parallel or perpendicular to such axes, or at an angle thereto.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or enhancing the image of the manufacturer or distributor. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “magnetic layer backed products” as used herein denotes products similar to prime labels but provided with a magnetized layer instead of the adhesive, as for example in so-called “refrigerator magnets”. The term “wide-web products” as used herein denotes posters or similar products that have no backing.

The varnish or coating that is used in the present invention may be applied by any conventional means, such as flood coating, pattern or spot coating, transfer coating or other suitable technology known in the industry. The coating may be applied so as to cover the full length and width of the material or substrate or may be applied in predetermined or selected areas so that only a portion of the substrate or sheet is provided with the varnish or coating.

The thickness of the coating ranges from about 0.0002″ to about 0.005″ and more preferably 0.0002″ to about 0.003″ with about 0.002″ being yet still more preferred. Typically, in a preferred embodiment the coating is applied through a coating roller but a flood coat sleeve or printing plate applicator may also be used. A particular range of viscosities is generally not required for the practice of this invention. However, those coatings with a higher viscosity will typically produce a greater contrast between the sheet or substrate and the coating that is employed.

For the exemplary embodiment being presently described, one preferred coating is a UV curable varnish, such as FT30LI available from Northwest Coatings Corp., Oak Creek, Wis. 53154 and is composed of various acrylate monomers and oligomers. The coating maintains a boiling point of greater than 200° C., a vapor density of greater than 1 (air=1), an evaporation rate of greater than 1 (n-Butyle Acetate=1), and a vapor pressure of less than 1 (MM HG at 25° C.).

The coating material may comprise 100% of the varnish or the varnish of the exemplary embodiment may contain from 0.01% to 99.99% varnish and then a second component may be provided in a range from 0.01% to 99.99%, with such second coatings including pigments, dies, starches, waxes, silicones, stabilizers, drying aids, fragrances and such other elements or components that may add desirable features or characteristics to the coating.

Sericol is a suitable UV coating available from Sericol of North Kansas City, Kans. and includes acrylate ester, vinaly monomer, acrylated urethane, alkanol amine, barium sulfate and a photoinitator. Sericol is a pigmentless material having an absorbing agent contained therein as well as being in a prescribed pH range.

The curing of the coating as used in the present invention is accomplished by at least one if not multiple UV curing stations which contain UV bulbs that are provided for curing purposes. The curing stations may use “H” bulbs described below and/or the Gallium bulb, which is also described below.

In practicing an exemplary embodiment of the present invention, a series of UV curing bulbs, which can be positioned in a side by side, adjacent or sequential configuration, can be used. In an exemplary embodiment, a single bulb may allow a UV cure rate of approximate 50 feet per minute, while plural bulbs disposed in a side-by-side or adjacent configuration permits a higher curing rate of approximately 75 feet per minute. Obviously, other curing station configurations may be used in order to increase the possible through put rate of the equipment and processing of the substrates to be printed.

Exemplary bulbs used in the embodiment of the present invention are “H” bulbs and Gallium doped bulbs suitable for use in the UV curing processes. However, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for deeper penetration. The UV bulbs such as those described above along with reflectors, to focus or concentrate the energy, are available from the GEW Company, located in North Royalton, Ohio. Alternatively, a combination of both topical and penetration curing can result in a combination of curing energies sufficient to carry out the present invention. It should be understood that other curing technologies may be used in the preparation of the coating on the substrate for the present invention.

The exemplary coating, despite the thickness normally will create a glossy finish and can be further manipulated through the addition of pigments, dyes, starches, etc. to produce a dulled or matte finish or a coating having a particular color or appearance in the final product.

Conventional printing technology such as flexography is desirable in the printing of films and other communication materials due to the economies that can be achieved when compared with other types of printing processes, such as lithography. However, there are a number of drawbacks in utilizing this process for certain applications, particularly in rending “prime” communications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced. With increasing sophistication of consumers, as well as technology and expectations from each, such effects may be undesirable to potential end users.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 250 lines per inch and still preferably more than 300 lines per inch, which is approximately equal to about 2500 to 3500 dots per inch (“DPI”) in order to create a high quality image that is intended to be aesthetically appealing to the consumer.

Turing now to a further discussion of the presently described embodiments set forth in the present invention, an exemplary coating that may be used in connection with the present invention is now set forth in the following Table 1. Other combinations and formulations are of course possible and the present invention is not limited by the scope of the following compositions.

| Component | % by Weight |
|---|---|
| UV Curable Varnish | 97% |
| PrintAide ® | 1.5% |
| Corn Starch | 1% |
| Pigment | .5% |
| Total | 100% |

A further exemplary coating used in connection with the present invention is now set forth in the following Table 2:

| Component | % By Weight |
|---|---|
| UV Curable Varnish | 99.9% |
| Pigment | .1% |

A further exemplary coating used in connection with the present invention is now set forth in the following Table 3:

| Component | % By Weight |
|---|---|
| UV Curable Varnish | 98.5% |
| Corn Starch | 1.5% |
| Total | 100% |

Of the foregoing compositions, that of Table 2 exhibits the fastest reflow deterioration of the lenticular pattern, while the composition of Table 3 has the slowest reflow rate.

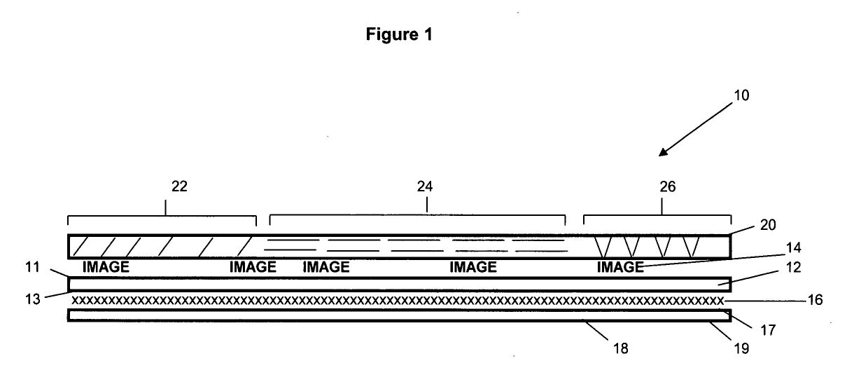

Reference is now directed to FIG. 1 in which a cross sectional view of a prime label assembly constructed in accordance with the present invention is provided. A prime label assembly is generally designated by reference numeral 10. It should be understood that while FIG. 1 and other FIGURES to be described herein show a cut sheet format, in which a single label or sheet of labels is presented, the invention is not so limited.

The prime label assembly includes a first layer or substrate 12 which has first and second faces 11 and 13, respectively. The first face 11 has an image 14 applied thereto. The image will preferably be printed at a resolution of greater than about 150 lines per inch and still more preferably at a resolution of greater than about 250 lines per inch. The image layer 14 is depicted by a series of repeating words “image”. The image may cover the entire area of the first surface or only a portion of the surface or face depending on the requirements of the end user. It should also be understood that while it is shown that an image is applied only to the first face 11 of the printable layer 12, an image may also be applied to the second face 13 of the printable layer 12.

For the prime label laminate or the magnetic layer backed product, a layer of pressure sensitive adhesive 16 is applied to the second face 13 of the first layer of substrate 12. The adhesive may be a permanent adhesive, removable or repositionable adhesive. Again, selection of the adhesive type will depend on the particular application being used by end user. The pressure sensitive adhesive 16 is covered by a release liner or magnetized layer 18 which has first and second faces 17 and 19, respectively, with the first face 17 in contact with the adhesive 16.

Continuing with a discussion of FIG. 1, a curable coating layer or varnish 20 is applied over the image 14. The curable coating layer 20 is provided with first 22, second 24 and third 26 patterns. As seen in FIG. 1, each of the patterns are distinct from one another so as to create visually, perceptibly distinct patterns that can be used to create different images when viewing the image through each of the patterns created in the curable layer 20.

Each of the first, second and third patterns are created in the curable layer in first, second and third areas (represented by the same reference numerals 22, 24 and 26) with each of the areas being distinct from one another. While each of the patterns/areas are shown as being substantially equal, the size of each of the areas may be varied depending on the desire of the end users.

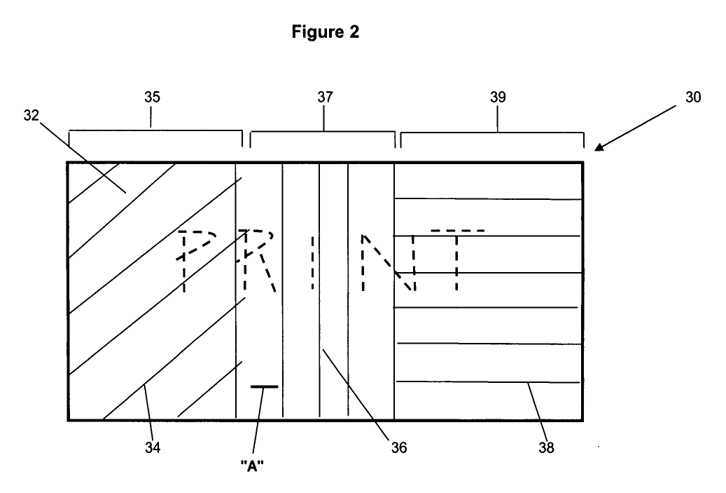

Turning now to FIG. 2 a front view of a prime label or magnetic backed assembly is provided and the assembly is generally depicted by reference numeral 30. The first surface or face “A” of the assembly 30 is provided with an image 32 (shown in phantom lettering) which runs substantially the length of the assembly 30.

The assembly 30 is provided with first 34, second 36 and third 38 patterns, with the first pattern 34 created in the first area 35; the second pattern 36 created in the second area 37; and the third pattern 38 created in the third area 39. Each of the patterns are created in the curable coating layer as previously described and comprise a geometric arrangement of striations which will create ridges and valleys in each of the areas as will be further described herein. Each of the patterns depicted in FIG. 2 are distinct from one another with the first pattern 34 running substantially diagonally; the second pattern 36 running vertically; and the third pattern running generally horizontally.

By providing a series of distinct patterns, the image 32 can be viewed at different angles thereby allowing the viewer to experience different variations in the image when the prime label assembly 30 is shifted in the viewing plane.

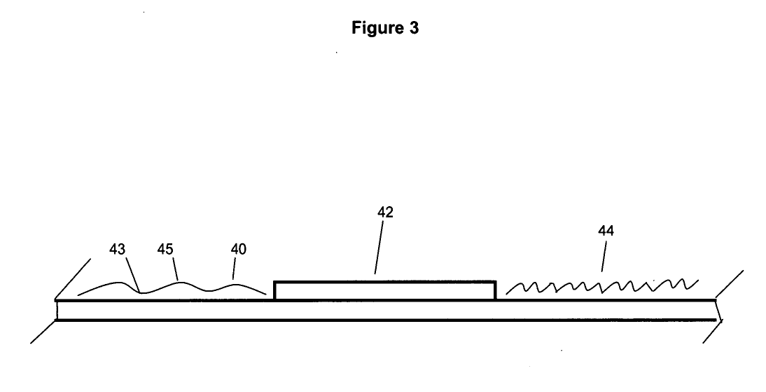

FIG. 3 provides a cross-sectional, exploded area of the curable coating showing the variations in the patterns and demonstrating the occurrence of ridges and valleys. Again three patterns, 40, 42 and 44 are shown and the difference in the cross section is related to the direction the pattern is created in the curable coating. Each of the patterns has regularly occurring peaks, represented by numeral 45 and valleys 43. Pattern 42 does not show the peaks and valleys as the pattern is cut perpendicularly to the first pattern. Pattern 44 shows peaks and valleys but as the pattern is cut diagonally to the other patterns, the peaks and valleys appear slanted.

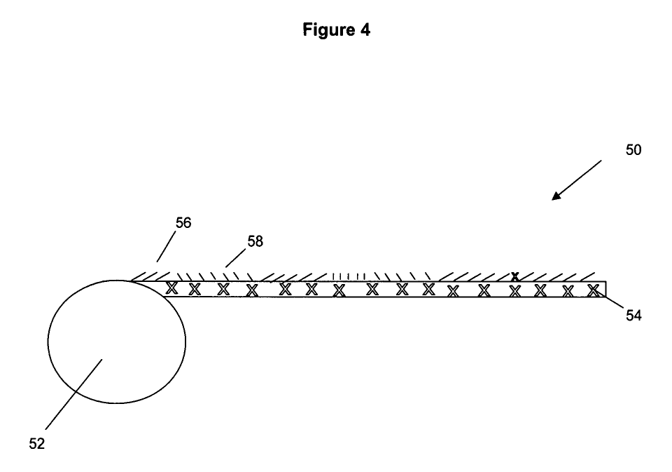

FIG. 4 is presented to briefly illustrate that the assembly 50 can be provided in a continuous roll configuration 52. The assembly 50 includes the substrate 54 having a series of two patterns 56 and 58. While other FIGURES depicts first, second and third patterns, it should be understood that only two patterns may be provided or more than three patterns can be created in the curable coating layer and that the invention is not so limited by any of the individual embodiments.

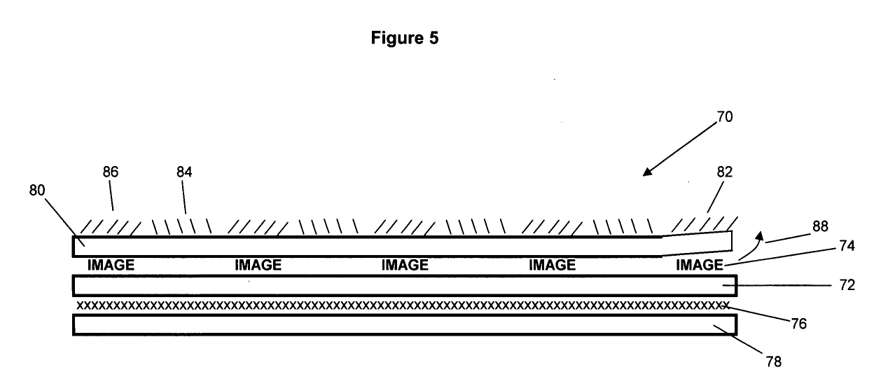

Turning now to FIG. 5 in which a cross sectional view of an alternate arrangement of the above-described assembly is provided. The assembly is generally designated by reference numeral 70. The assembly 70 includes a first layer 72 which has an image 74 applied to one side and a pressure sensitive adhesive 76 applied to another side opposite the image side. The adhesive 76 is covered by a release liner 78.

A film layer 80, such as a PET or polyvinyl layer, is applied over the image layer. The film layer 80 will preferably be transparent or substantially transparent so that the image is visible. A curable coating 82 is applied over the top of the film layer 80 and first and second patterns, 84 and 86, respectively, are created in the coating layer.

As shown in FIG. 5 by the arrow 88 the film layer may be peeled away from the image 74, such as through the use of a frangible coating (not shown) such that the film layer can be repositioned and the angles at which the image may be viewed can be changed to provide a further viewing experience. In addition, if the consumer does not wish to view the image through the lenticular field, then the user can easily remove the film from the assembly.

The patterns can be created in the curable coating by any suitable means, such as by a grooved roller, rake, pins or the like. Once the pattern is created, the patterns are cured as described above.

It will thus be seen according to the present invention a highly advantageous prime pressure sensitive label assembly, magnetically backed product or wide-web product having discernibly distinct patterns has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A pressure sensitive prime label assembly, comprising;
a) a release liner having first and second faces, with said first face having a coating of release material applied substantially over said first face;
b) a pressure sensitive adhesive layer applied over said first face of said release liner;
c) a printable layer applied over said adhesive layer, said printable layer having first and second faces with at least said first face having an image produced thereon;
d) a curable coating material applied over at least said first face; and
e) at least first and second patterns created in said curable coating material over said first face, with said first pattern distinct from said second pattern and each of said first and second patterns creating distinct dimensional images.

2. A pressure sensitive prime label assembly, as recited in claim 1, wherein said assembly includes a third pattern created in said curable coating material and distinct from each of said first and second patterns.

3. A pressure sensitive prime label assembly, as recited in claim 1, wherein said assembly includes a substantially transparent film layer applied over said first face of said printable layer.

4. A pressure sensitive prime label assembly, as recited in claim 3, wherein said curable coating is applied over said substantially transparent film layer.

5. A pressure sensitive prime label assembly, as recited in claim 3, wherein said substantially transparent film layer is strippable from said printable layer.

6. A pressure sensitive prime label assembly, as recited in claim 1, wherein each of said first and second patterns create distinct images in cooperation with said image on said printable layer first face.

7. A pressure sensitive prime label assembly, as recited in claim 1, wherein each of said curable coating has a boiling point of greater than 200° C. and a vapor pressure of less than 1 MM HG at 25° C.

8. A pressure sensitive prime label assembly, as recited in claim 1, wherein said curable coating has a thickness ranging from about 0.0002″ to about 0.005″.

9. A pressure sensitive prime label assembly, as recited in claim 1, wherein said curable coating includes a first component ranging from 0.01% by weight to 99.99% by weight and a second component ranging from 0.01% by weight to about 99.99% by weight.

10. A pressure sensitive prime label assembly, as recited in claim 9, wherein said second component of said curable coating is selected from a group including pigments, dies, starches, waxes, silicones, stabilizers, drying aids, fragrances and combinations thereof.

11. A permanent pressure sensitive prime label, comprising;
a) a first layer having first and second faces with at least one of said faces having an image applied thereto;
b) a curable varnish applied over said image so as to at least substantially cover said image;
c) a permanent pressure sensitive layer applied to said second face of said first layer, said permanent pressure sensitive layer covered by a release liner;
d) a first pattern created in a first area of said curable varnish; and
e) a second pattern distinct from said first pattern created in a second area of said curable varnish.

12. A permanent pressure sensitive prime label as recited in claim 11, wherein said image is produced at a resolution of greater than about 150 lines per inch.

13. A permanent pressure sensitive prime label as recited in claim 11, wherein said first and second patterns create visibly distinct discernable patterns.

14. A permanent pressure sensitive prime label as recited in claim 11, wherein said label includes a third pattern created in said varnish, said third pattern distinct from each of said first and second patterns and in a third area separate from each of said first and second areas.

15. A permanent pressure sensitive prime label as recited in claim 11, wherein said first and second areas are substantially equivalent.

16. A permanent pressure sensitive prime label as recited in claim 11, wherein at least one of said first and second patterns includes a regularly occurring series of ridges and valleys.

17. A permanent pressure sensitive prime label as recited in claim 11, wherein said pressure sensitive prime label is provided in a continuous format.

18. A permanent pressure sensitive prime label as recited in claim 11, wherein said pressure sensitive prime label is provided in a cut sheet format.

19. A prime label assembly, comprising;
a) a first layer having an image deposited on a first face, said image having a resolution of greater than about 150 lines per inch;
b) a layer of adhesive applied to said first layer on a second face opposite said first face, said layer of adhesive covered by a release liner;
c) a UV curable coating applied over said image; and
d) at least first and second patterns created in said UV curable coating, said first and second patterns are created in first and second areas that are distinct from one another.

20. A prime label assembly as recited in claim 19, wherein said label assembly includes at least a third pattern created in said curable coating, with said third pattern applied in a third area distinct from said first and second areas.

21. A magnetically backed lenticular assembly, comprising:
a) a layer of magnetized material;
b) a pressure sensitive adhesive layer applied over a face of said magnetized layer;
c) a printable layer applied over said adhesive layer, said printable layer having first and second faces with at least said first face having an image produced thereon;
d) a curable coating material applied over at least said first face of said printable layer; and
e) at least first and second patterns created in said curable coating material over said first face, with said first pattern distinct from said second pattern and each of said first and second patterns creating distinct dimensional images.

22. A wide-web lenticular product, comprising;
a) a printable layer having first and second faces with at least said first face having an image produced thereon;
b) a curable coating material applied over at least said first face; and
c) at least first and second patterns created in said curable coating material over said first face, with said first pattern distinct from said second pattern and each of said first and second patterns creating distinct dimensional images.
